(19) United States
(12) Patent Application Publication
(10) Pub. No.: US 2026/0299805 A1
(43) Pub. Date: Oct. 1, 2026

(54) EFFICIENT STORAGE ALLOCATION BASED ON SUPPLY AND DEMAND MATCHING

(71) Applicant: Oracle International Corporation, Redwood Shores, CA (US)

(72) Inventors: Tao Mao, Palo Alto, CA (US); Yanfei Fan, Palo Alto, CA (US)

(73) Assignee: Oracle International Corporation, Redwood Shores, CA (US)

(21) Appl. No.: 19/090,278

(22) Filed: Mar. 25, 2025

(51) Int. Cl. G06F 3/06

(52) U.S. Cl. CPC G06F 3/0631; G06F 3/061; G06F 3/064; G06F 3/0673

(57) ABSTRACT

A computer program product, system, and computer implemented method for efficient storage allocation based on supply and demand matching is provide that continually adjusts the available demand characteristics to historic demand characteristics. Generally, the approaches provided herein provide new procedures to quantify the distribution of storage allocations. These storage allocations maybe thought of as chunks which may be different sizes and which are quantified for both available storage chunks (supply) and storage allocation requests (demand). Specifically, a dynamic allocation approach is used to continually adjusts the available allocations to match past demand as a proxy for future demand and to provide for continual adjustment of available supply by at least making allocation determinations that address deviations of the actual supply from the measured demand. The approaches provided herein are applicable to at least caches, memory, flash, and disks (logical or physical or both).

### BACKGROUND

In the realm of data storage, one of the long-standing challenges is the issue of storage fragmentation. Fragmentation occurs when data is stored in non-contiguous sections of a storage medium, leading to inefficient use of space and slower access times. This fragmentation typically arises in systems that allow dynamic data writing, modification, and deletion, such as hard disk drives (HDDs), solid-state drives (SSDs), and file systems.

As data is written to a storage device, it is often stored in small pieces across various locations. Over time, as files are added, modified, and deleted, gaps and fragments appear. When a new file or data is written to the storage device, it may not fit into the contiguous space available, resulting in the data being split and scattered across different parts of the storage medium. This scattered data can lead to several operational inefficiencies, including slower read and write speeds, increased access times, and greater wear on the physical storage components. For instance, when a storage device retrieves fragmented data, it may require more movements (e.g., read operations), especially on mechanical HDDs, which further exacerbates performance degradation.

In addition to performance issues, fragmentation also leads to inefficient storage space utilization. Despite having available free space on the storage device, fragmentation may prevent that space from being used effectively, as it might not be contiguous. This inefficiency becomes more apparent in large-scale storage systems or cloud environments, where data fragmentation can quickly accumulate and result in a significant loss of usable space.

The consequences of fragmentation are compounded by the increasing volume of data that must be managed in modern computing environments. With the growing demands for high-speed data access, large-scale storage solutions are required to handle increasingly complex workloads. Therefore, addressing the problem of fragmentation is essential for improving both the performance and capacity of storage systems.

Existing solutions, such as defragmentation tools, attempt to reorganize fragmented data into contiguous blocks to restore storage efficiency and performance. However, these methods often come with their own set of challenges, such as the need for significant processing power, the risk of data loss during the defragmentation process, and the downtime associated with performing these operations. Moreover, for solid-state drives (SSDs), traditional defragmentation methods are less effective and may even reduce the lifespan of the device due to excessive write operations.

As a result, there is an ongoing need for more efficient methods and systems for managing storage fragmentation that can enhance performance, optimize space utilization, and improve the reliability and longevity of storage devices.

### SUMMARY

Embodiments of the present disclosure provide a method, apparatus, and product for efficient storage allocation based on supply and demand matching.

Generally, the approaches provided herein provide new procedures to quantify the distribution of storage allocations. These storage allocations maybe thought of as chunks which may be different sizes (e.g., chunks of 1, 2, 3, 4, 5, etc. blocks). These chunk allocation sizes may be quantified for both available storage chunks (supply) and storage allocation requests (demand). As provided herein, this information is used to optimize the selection of storage chunks for storage allocation. Specifically, the available supply can be matched to the historic demand using a dynamic allocation approach that continually adjusts the available allocations to match past demand as a proxy for future demand and to provide for continual adjustment of available supply using at least allocation determinations that address deviations of the actual supply from the measured demand. This storage allocation mechanism can be applied to various kinds of storage media, such as caches, memory, flash, and disks. In some embodiments, approaches provided herein can be applied to allocation of both logical and physical memory or storage. Examples of applicable areas include at least file system management, memory management, cloud block storage allocation, mobile/wearable device storage allocation, and cache allocation.

Further details of aspects, objects, and advantages of the disclosure are described below in the detailed description, drawings, and claims. Both the foregoing general description and the following detailed description are exemplary and explanatory and are not intended to be limiting as to the scope of the disclosure.

### BRIEF DESCRIPTION OF THE DRAWINGS

The drawings illustrate the design and utility of embodiments of the present disclosure, in which similar elements are referred to by common reference numerals. To better appreciate the advantages and objects of embodiments of the disclosure, reference should be made to the accompanying drawings. However, the drawings depict only certain embodiments of the disclosure, and should not be taken as limiting the scope of the disclosure. The drawings use like reference numerals to identify like elements, and unless otherwise specified, any description for that element may be applicable to each use of that reference numeral were appropriate.

FIG. 1 illustrates an example system in which some embodiments of the disclosure may be implemented.

FIG. 2 illustrates a flow for efficient storage allocation based on supply and demand matching according to some embodiments.

FIG. 3A illustrates a flow for generating a storage unit availability representation according to some embodiments.

FIG. 3B illustrates a flow for processing the storage space representation to generate chunk supply data according to some embodiments.

FIG. 4A illustrates a flow for processing allocation requests using allocation logic according to some embodiments.

FIG. 4B illustrates a flow for updating chunk supply data, chunk demand data, and chunk supply/demand ratio data after a previously free chunk is allocated according to some embodiments.

FIG. 4C illustrates a flow for updating chunk supply data and chunk supply/demand ratio data after a previously used chunk is de-allocated according to some embodiments.

FIG. 5 illustrates a flow for selecting a chunk size based on desirability of a remainder and chunk size availability according to some embodiments.

FIG. 6A provides an illustrative example of chunk supply data generation for a storage element with all allocation units available according to some embodiments.

FIG. 6B provides an illustrative example of chunk supply data generation for a storage element with only some allocation units available according to some embodiments.

FIG. 6C provides an illustrative example of how to determine chunk size allocation in the event that an exact fit approach is not possible according to some embodiments.

FIG. 7 is a diagram of a computing system suitable for implementing an embodiment of the present disclosure.

FIG. 8 is a block diagram of one or more components of a system environment in which services may be offered as cloud services, in accordance with an embodiment of the present invention.

### DETAILED DESCRIPTION OF THE EMBODIMENTS OF THE DISCLOSURE

Various embodiments are described hereinafter with reference to the figures. It should be noted that the figures are not necessarily drawn to scale. It should also be noted that the figures are only intended to facilitate the description of the embodiment(s) and are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated.

As provided herein, there are many instances where a computing process (e.g., file system management, memory management, cloud block storage allocation and defragmentation, mobile/wearable device storage allocation, cache allocation, and email compaction, etc.) need to allocate storage for applications on the fly while minimizing storage fragmentation for storage or memory management. The present approach describes new procedures to achieve this goal by at least predicting (based on allocation demand history) a future allocation demand (e.g., storage request patterns) and tracking available allocation supply, where the available allocation supply and predicted future allocation demand (e.g., represented by the allocation demand history) are used to make allocation determinations. Those allocation determinations apply logic that encourages the creation of chunks having desirable sizes that are in low supply as determined based on the supply and demand information. This also discourages the creation of chunks of sizes that are less desirable. Thus, the approaches provided herein represent an improvement to the prior approaches such as first-fit (selects the first chunk encounter that is big enough to satisfy the allocation request) and best-fit (selects the chunk that would have the smallest remainder to satisfy the allocation request).

Generally, as provided herein allocations occur at the level of one or more chunks (allocation chunks). Those chunks represent the smallest allocation size in a computing process which manages memory and/or storage (whether logical or physical or both). When an allocation request is received it has or is associated with a given size. That size can be mapped to a number of chunks that are necessary to satisfy the allocation request.

Ideally, a chunk of the exact size requested is available and can be used to completely fill a corresponding contiguous area. However, this does not address how to handle requests where an exact fit cannot be achieved. When an exact fit cannot be achieved a chunk size is selected (subject to availability) that provides a remainder (e.g., another contiguous area) that is most desirable based on at least predicted demand (e.g., as represented by an allocation demand history).

As provided herein the present approach provides at least chunk supply data and chunk demand data. Generally, the chunk supply data is a data structure where the available chunks are counted according to a binning mechanism such that the corresponding storage is counted only once and only for its largest contiguous area. Thus, the supply data provides a count of the number of available chunks and their sizes that can be provided by a storage element. The demand history is largely similar in that it bins allocation requests by size and provides a count of a number of requests of each size (e.g., chunk size) requested that falls within a specified criteria (e.g., during a sliding time window or a specified number of latest allocation requests). As will be discussed further herein the supply and demand information can be used to form a ratio value for each matching chunk size such as where the lower the value the more desirable it would be to have a remainder of an allocation equal that chunk size. However, other approaches could be provided herein including weighting based on supply, demand, or both. Additionally, the ratio could be inverted to represent the demand/supply where the higher the value the more desirable it would be to have a remainder of an allocation equal that chunk size.

In some embodiments, the chunk supply data or the chunk demand data could be maintained in memory, on a non-volatile storage device, or a combination thereof. In some embodiments the ratio data may be maintained in memory, on a non-volatile storage device, generated dynamically as needed, or a combination thereof. In some embodiments, chunk sizes that have no supply or no demand do not have a corresponding entry in the chunk supply data or the chunk demand data respectively. In some embodiments, the chunk supply data, the chunk demand data, or both are represented using a map-based representation to improve the efficiency of the storage of the corresponding data.

In some embodiments, the approaches comprise generating a storage unit availability representation of a storage unit, and processing the storage unit availability representation to generate chunk supply data, wherein the chunk supply data maps chunk sizes to a corresponding count of a number of chunks having a matching chunk size. In some embodiments, the approaches further comprise receiving an allocation request, and processing the allocation request using allocation logic, wherein the allocation logic uses at least the chunk supply data and chunk demand data to determine a chunk size to use for the allocation request.

In some embodiments, the approaches further comprise updating the chunk supply data by at least decrementing a count of the chunk size in the chunk supply data, and updating the chunk demand data by at least incrementing a count of the chunk size in the chunk demand data. In some embodiments, allocation logic uses a ratio of a count of the chunk size in the chunk supply data divided by a count of the chunk size in the chunk demand data to determine the chunk size's desirability to use for the allocation request. In some embodiments, a ratio of a count of a chunk size in the chunk supply data divided by a count of the chunk size in chunk demand data is dynamically calculated in response to the allocation request.

In some embodiments, the approaches comprise updating chunk supply data by at least incrementing a count of a different chunk size that is equal to a chunk remainder size left over from processing an allocation request. In some embodiments, the approaches comprise updating chunk demand data by at least decrementing the counts of chunk sizes that are outside the specified sliding time window or specified number of latest requests. In some embodiments, chunk sizes are a multiple (e.g., one or more) of a smallest allocation size that is supported for the storage unit. In some embodiments, chunks represent a contiguous collection of one or more storage units, the chunk sizes are equal to a number of corresponding contiguous storage units, and each storage unit is only counted towards one chunk.

In some embodiments, chunk demand entries, allocation timestamps, or both are added to an allocation log to track allocation requests. In some embodiments, chunk demand entries or allocation timestamps that match inclusion criteria (e.g., specified by a sliding time window or number of latest requests) are processed to generate the chunk demand data.

In some embodiments, a subsequent allocation request that exactly matches a remainder chunk size from processing a prior allocation request is processed using allocation logic to determine that an exact fit allocation technique is to be used to assign the remainder chunk for the subsequent allocation request.

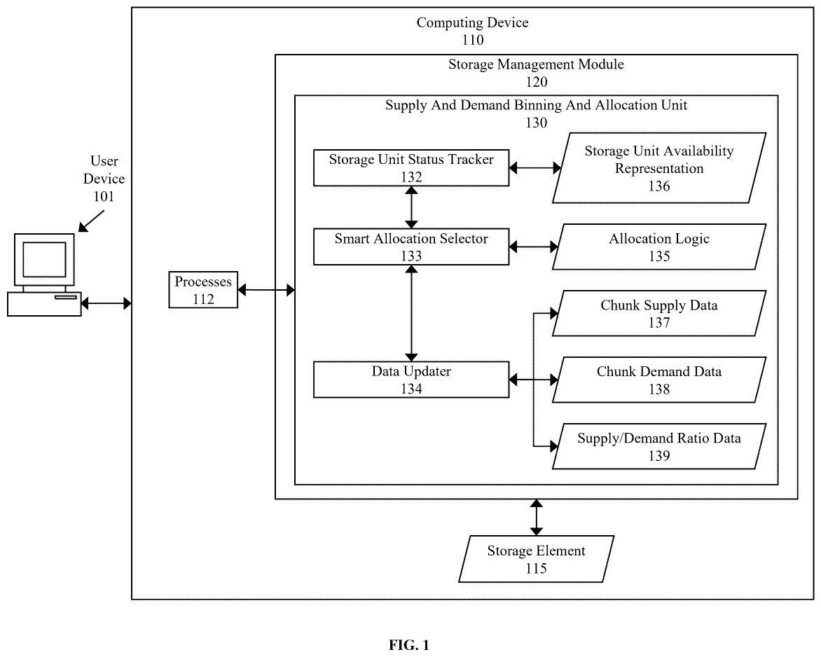

FIG. 1 illustrates an example system in which some embodiments of the disclosure may be implemented. Generally, the example system includes a computing device having a storage element that allows for the data stored therein to change over time. However, the approaches provided herein may be applicable to the management of any storage element(s) that may be subject to fragmentations-e.g., due at least in part to support for write operations.

For instance, the storage element (see e.g., 115) may comprise a HDD, an SSD, a RAM, a cache, a distributed storage arrangement or any combination thereof. As provided herein, the present approach provides for dynamically and continually adjusting the storage allocations that are used and available based on supply and demand matching to increase storage efficiency while minimizing the workload created by the allocation approach.

Additionally, while only a single computing device is illustrated, the present approaches could be utilized for multiple storage elements of one or more types. Such approaches may include management of cluster level resources such as distributed storage or caches. A cluster may comprise a number of nodes (e.g., storage nodes and compute nodes) that perform compute and storage functions on behalf of one or more users that access the cluster using one or more user devices.

As illustrated, the example system includes a computing device (see 110) and may be accessible using one or more user devices (see e.g., user device 101). For instance, in some embodiments, the computing device comprises a storage node or a compute node that is directly or indirectly accessible via the user device.

As an initial matter, a user device (e.g., 101) may interact with a computing device using one or more sessions. Both the user device 101 and the computing device 110 comprises any type of computing device that may be usable for one or more computer functions, whether directly or indirectly. Examples of such a computing device include workstations, personal computers, laptop computers, or remote computing terminals. Computing devices may also comprise any type of portable tablet device, including for example, tablet computers, and portable readers. Computing devices may also include any mobile device that can suitably access any computing systems on the Internet such as smartphones and mobile handsets. It is noted that this disclosure is not limited in its application to just these types of devices. The embodiments of the disclosure are applicable to any computing device that works in conjunction with access to digital information stored on, as an example, the Internet. One of ordinary skill in the art may appreciate that embodiments of the present disclosure may be implemented on the Internet, on a closed network, on a hybrid open and closed network, or on a cloud network.

Furthermore, the user device can be controlled by a user, a service, an administrator, or comprise any other user device that allows for access or management of data. Additionally, a storage element (see e.g., 115) may be associated with any number of users via one or more computing devices that are each in turn associated with one or more user devices such as user device 101. In some embodiments, a computing device and user device may be combined together.

As provided herein, a computing device (see e.g., 110) executes one or more processes (see e.g., 112). In the context of a distributed or cloud computing system or cluster, such processes are executed on a session-by-session basis, where a user may start a session with a computing device and control the execution of one or more workflows or processes. As part of the performance of those workflows or processes, the user process may generate requests to perform operations that comprise or are associated with allocation requests. For example, the user process may cause requests such as filed creation, file initialization, file open, file read, file write, or file delete (e.g., trim) operations. Such request would be forwarded to a corresponding storage management module on the node (e.g., 120) to perform the requested operation.

Generally, a storage management module (e.g., 120) performs operations to determine one or more locations that need to be accessed to service an access request. For instance, in the event of a read operation, the file manager module would perform a lookup to determine where the requested information is stored and generate one or more read operations to retrieve the requested information from one or more corresponding storage elements (see e.g., storage element 115). The requested information would then be packaged up together and provided in response to the read request from original requestor (e.g., process). Similarly, when an operation is received that requires allocation of additional space in a storage element (see e.g., 115), the storage management module would determine where that allocation should be provided from. For example, a request to store an object (e.g., file) in a block-based storage system would be associated with an allocation of a number of blocks sufficient to store the object. Present approaches for managing this generally use a first-fit or best-fit approach. A first-fit approach comprises selecting the first free storage chunk that is equal to or larger than the requested size. A best-fit approach comprises selecting a chunk that would leave the smallest remainder. Unfortunately, neither of these approaches account for demand. As a result, storage elements that are managed using such approaches generally become fragmented fairly rapidly and thus the storage elements managed in this way require frequent defragmentation.

The present approach improves on the prior approaches by at least making allocation determinations in a way that account for supply and demand by at least allocating chunks in such a way that the allocation thereof continually adjusts the supply to match the demand. Those allocation determinations may be made by a supply and demand binning and allocation unit (see e.g., 130) which may be included within a storage management module (see e.g., 120) as provided herein. In some embodiments, the supply and demand binning and allocation unit comprises a storage unit status tracker (see 132), a smart allocation selector (see 133), and a data updater (see 134). Additionally, the supply and demand binning and allocation unit includes or manages one or more sets of data comprising a storage unit availability representation (see 136), allocation logic (see 135), chunk supply data (see 137), chunk demand data (see 138), supply/demand ratio data, or some combination thereof.

In some embodiments, the storage unit status tracker 132 comprises one or more processes to generate a representation of available storage space for one or more storage elements (see e.g., 115). For example, the storage unit availability representation comprises a vector where each value represents whether a corresponding area is used (e.g., 1 or 0) or available (e.g., 0 or 1). The corresponding area generally comprises the smallest allocation size that is supported using the storage element. For instance, if the storage element is a block-based device, each block can be represented by a single bit in the vector. As provided herein, the storage unit availability representation may be created at bootup or upon provisioning the storage element, and may be updated as portions thereof are allocated and freed.

In some embodiments, the data updater 134 comprises one or more processes to generate and maintain data for use by the smart allocator. For example, the data updater may generate and maintain chunk supply data 137, chunk demand data 138, and supply/demand ratio data 139. Briefly, the data updater initially generates chunk supply data by parsing the storage unit availability representation 136 and creating entries that represents a sum of the number of available chunks of each size (e.g., a count of the number of chunks of size 1, 2, 3, 4, 5, 6, etc.) without counting subsets of a chunk (e.g., a chunk of size 2 is counted only as a chunk of size 2 and not as 2 chunks of size 1). Similarly, chunk demand data is collected at 138. Generally, this comprise collecting a number of allocations or allocation requests that fall within a tracked time frame. Each allocation or allocation request is counted only for the exact size needed. Finally, supply/demand ratio data is maintained at 139. This information can be generated for each chunk size. For example, a count of the number of available chunks of size 4 (represented in the chunk supply data) is divided by a number of allocations or allocation requests for a chunk of size 4 (represented in the chunk demand data) to get a value that represents the ratio.

In some embodiments, the smart allocation selector 133, upon receipt of an operation necessitating an allocation or an allocation request, applies allocation logic to determine which chunk size to use for the allocation. In some embodiments, the allocation logic uses an exact-fit approach when possible, where if the allocation can be accomplished using a chunk of the exact size requested the allocation is then accomplished using a chunk of the exact size. In the event that an exact fit allocation cannot be accomplished, the smart allocation selector applies a set of logic (see e.g., 135) to determine what size chunk should be used for the allocation such that the supply and demand is accounted for by selecting an allocation that has a most desirable remainder. This remainder would then become a chunk having a size of the remainder. In some embodiments, the smart allocation selector and the allocation logic is combined using a compiled representation of the allocation logic. In some embodiments, the allocation logic comprises a plurality of rules to be applied to determine what chunk size to select for allocation. In some embodiments, the smart allocation selector and at least some of the allocation logic is combined using a compiled representation of the allocation logic and the remainder of the allocation logic comprises at least one or more parameters that can be tuned to manage the selection of chunks to use for allocation. In some embodiments, the allocation logic processes chunk supply data to determine whether there is any chunk that exists that can satisfy an allocation request (e.g., whether exact-fit can be used or at least a chunk of sufficient size exists). In some embodiments, if no chunk exists that are sufficiently large to satisfy an allocation request, the process implements a defragmentation process to generate one or more chunks of sufficient size. In some embodiments, a deallocation request (e.g., trim or delete operation) is also processed using the smart allocation selector (see e.g., 133). For example, deallocation requests may be processed to update the corresponding chunk supply data, and in some embodiments the supply/demand ratio data.

In some embodiments, the storage unit availability representation 136, the chunk supply data 137, the chunk demand data 138, and the supply and demand ratio data 139 are updated at after one or more allocation operations (e.g., after each operation, after a specified number of allocations, after a specified time frame or sliding window). In some embodiments, the storage unit availability representation 136, the chunk supply data 137, the chunk demand data 138, and the supply/demand ratio data 139 are updated at after one or more operations that free one or more chunks (e.g., after each free operation, after a specified number of free operations, after a specified time frame or sliding window). In some embodiments, the supply/demand ratio data 139 is computed on demand for each allocation whenever an exact-fit approach cannot be used. In some embodiments, any combination of one or more of the elements of the supply and demanding binning an allocation unit are maintained in a temporary storage structure elements such as RAM or cache.

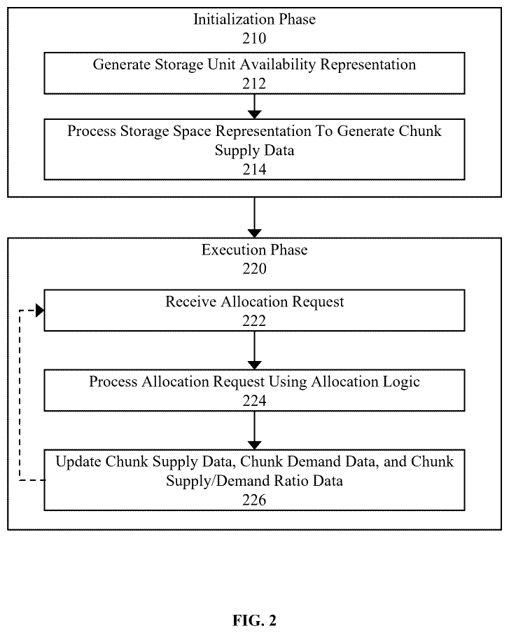

FIG. 2 illustrates a flow for efficient storage allocation based on supply and demand matching according to some embodiments. Generally, the approach comprises two phases, an initialization phase and an execution phase. However, other approaches could be provided that perform the same or essentially the same operations but in a different order.

In some embodiments, in the initialization phase (210) operations are performed to populate the relevant data structures. For instance, a first flow is implemented to generate a storage availability representation at 212—see e.g., the storage unit availability representation 136. Subsequently, a second flow is implemented to process the storage availability representation generated at 212 in order to generate chunk supply data at 214—see e.g., the chunk supply data 137. In some embodiments, the initialization phase is executed upon bootup, mounting, or provisioning a to be managed storage element, or as part of a failure recovery process.

In some embodiments, during the execution phase (220) operations are performed in response to requests that require allocations or comprise allocation requests. For example, an allocation request is received at 222 which triggers the processing of the allocation request using the allocation logic (or an embodiment thereof) to determine the chunk size to use for the allocation at 224. In some embodiments, the storage unit availability (e.g., the storage unit availability representation 136) is updated in response to execution of the allocation. In some embodiments, a de-allocation request is received at 222 and processed at 224 to free a previously allocated chunk.

Subsequently, at 226, the chunk supply data (see e.g., 137), chunk demand data (see e.g., 138), and in some embodiments the chunk supply/demand ratio data (see e.g., 139) are updated to account for the allocation. For instance, the storage unit status tracker 132 updates the storage unit availability representation 136, and the data updater 134 updates the chunk supply data (see e.g., 137), and chunk demand data (see e.g., 138), and in some embodiments the chunk supply/demand ratio data (see e.g., 139). In some embodiments, a de-allocation request, received at 222 and processed at 224 to free a previously allocated chunk, triggers processing to update chunk supply data and in some embodiment supply/demand ratio data at 226, but does not trigger an update to chunk demand data.

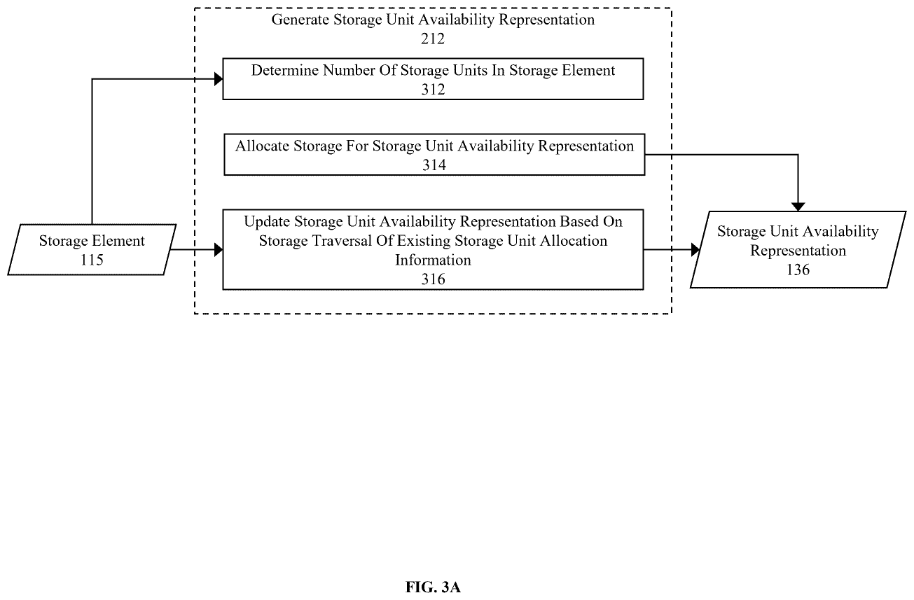

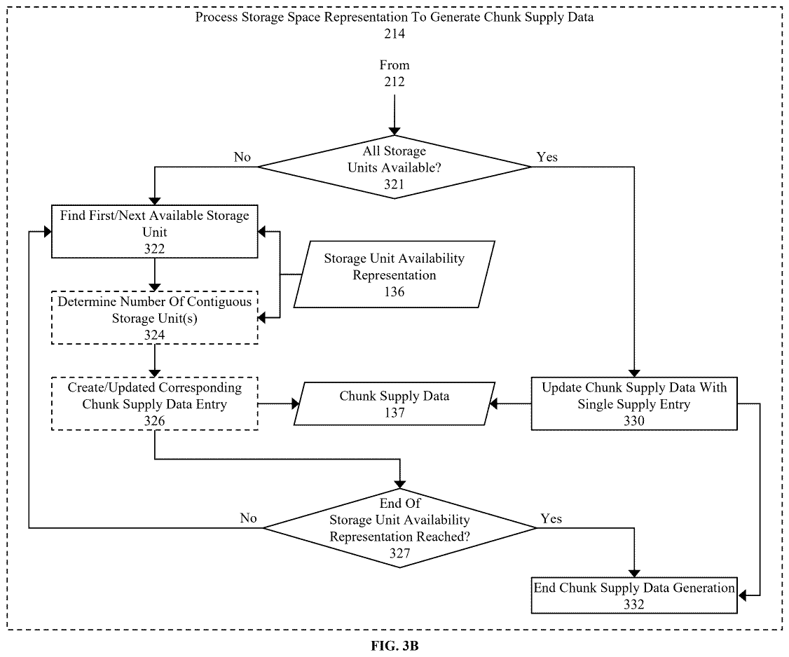

FIG. 3A illustrates a flow for generating a storage unit availability representation according to some embodiments. However, other approaches could be provided that perform the same or essentially the same operations but in a different order.

As illustrated, the process starts by determining a number of storage units in the storage element at 312. Generally, the storage unit is equal to the smallest allocatable size of storage that is supported by the storage element—e.g., a block in a block-based storage element. After the number of storage elements is determined at 312, an allocation operation occurs to cause the allocation of storage for the storage unit availability representation at 314. For example, an amount of memory (e.g., RAM) is allocated to the storage unit availability representation.

The storage unit availability representation 136 is then updated at 316 based on a traversal of the existing storage unit allocation information. For example, on or more file allocation tables can be traversed to determine which blocks are in use and based on an absence of use, which blocks are not in use.

FIG. 3B illustrates a flow for processing the storage space representation to generate chunk supply data according to some embodiments. However, other approaches could be provided that perform the same or essentially the same operations but in a different order.

In some embodiments, the chunk supply data generation is triggered by the completion of the generation of the storage unit availability representation (see 212). In some embodiments, the process starts by determining whether all storage units are available. For instance, partition information or a flag can be read to determine whether all chunks are available at 321. If all chunks are available the process proceeds to 330 where the chunk supply data is updated to include a single supply entry. That single supply entry specifies that it has a size equal to the number of storage units available and has a count of 1. After which the process proceeds to 332 where the chunk supply data generation is ended.

In response to a determination that only a subset of the storage units are available, the process proceeds to 322 where a first available storage unit is found. For example, if the storage unit availability representation comprises a vector having zeros to indicate free storage units and ones to indicate used storage units, then the vector can be traversed to find the first occurrence of a transition from a one to a zero (e.g., 10) to identify an available storage unit (chunk).

Subsequently, the number of contiguous storage units can be determined which corresponds to the chunk size. To illustrate, if we continue the example for 322, the vector can be traversed to find the first subsequent occurrence of a transition from a zero to a one (e.g., 01) to identify a break or end of the contiguous chunk. Once the end of the contiguous chunk has been identified a corresponding entry is created or updated in the chunk supply data at 326. For example, upon the first encounter of a chunk of the determined size, a new entry would be created that associates the chunk size, to a count that is initially set to one. For each subsequent occurrence, the count is incremented by one.

At 327, it is determined whether the end of the storage unit availability representation has been reached. In response to a negative determination the process proceeds back to 322 in a loop. There are three potential corner cases that may need to be addressed as well. A first corner case occurs when the very first entry is available (e.g., is represented by a zero). In such an instance, the first entry would be identified as a first available storage unit. A second corner case occurs when the last entry is available. In this instance, reaching the last entry is used to identify the end of the contiguous chunk. A third corner case occurs when the attempt to identify the first/next available storage unit fails at 322. In response to such an occurrence the process will proceed directly to 327 where the flow is routed to 332.

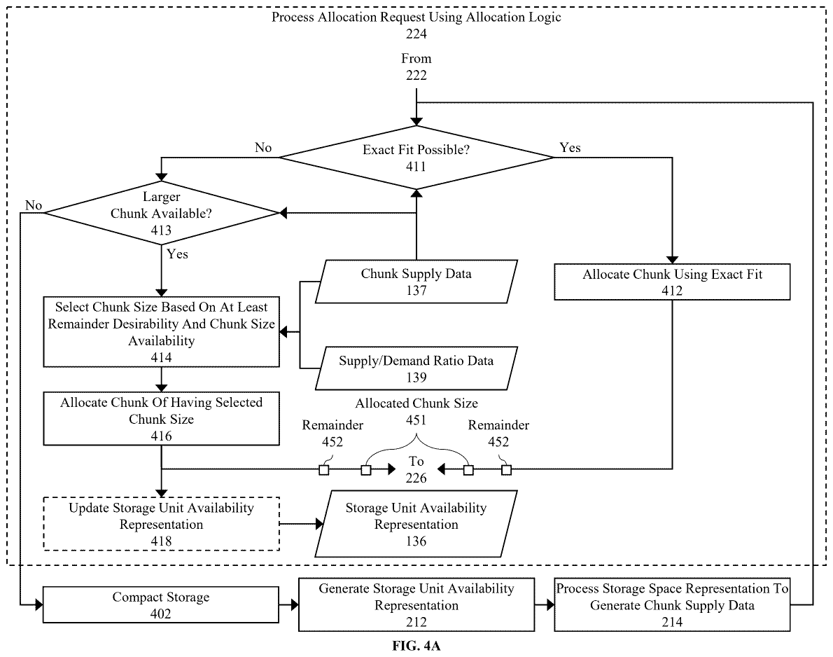

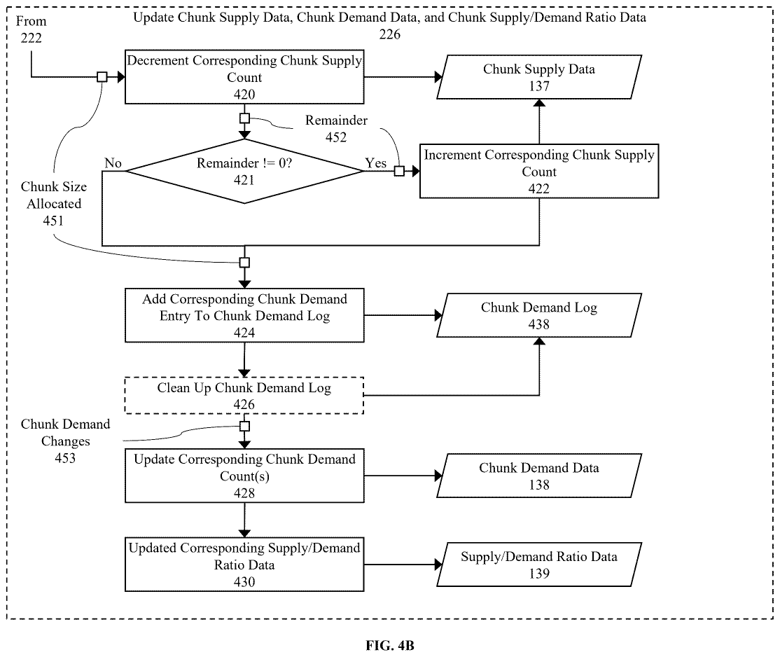

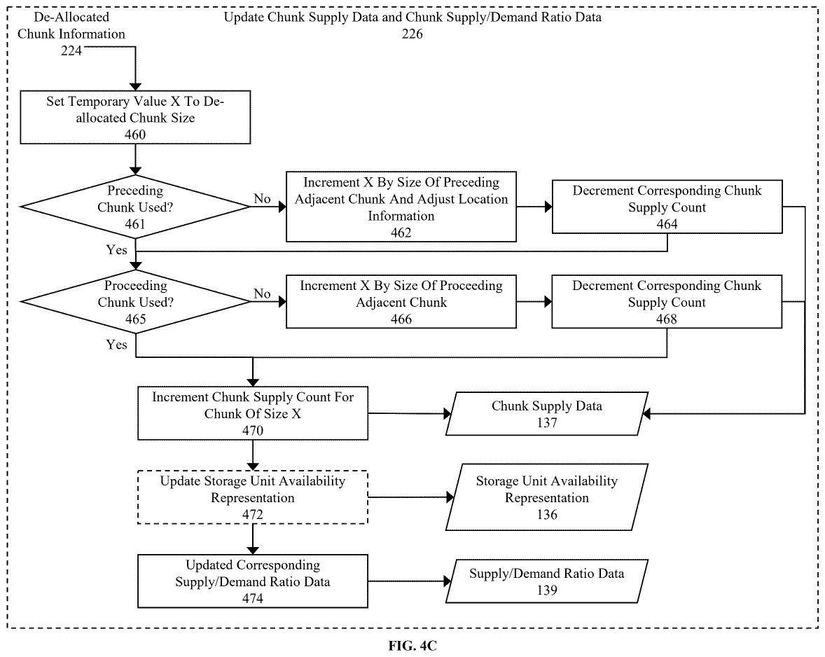

FIG. 4A illustrates a flow for processing allocation requests using allocation logic according to some embodiments. Generally, the process is initiated in response to receipt of an allocation request or request that requires an allocation at 222. However, other approaches could be provided that perform the same or essentially the same operations but in a different order.

In some embodiments, the process starts at 411 by determining if an exact-fit allocation is possible. For example, the process can compare the chunk size required for the allocation to the chunk supply data to determine whether there are any chunks of that size available. In response to a determination in the affirmative, the process proceeds to 412 where a chunk having the exact size required/requested is allocated for the request. Subsequently, the chunk allocation size (see e.g., 451) and the remainder (see e.g., 452), which would be zero when exact-fit is used, is captured and transmitted to 226 as discussed herein.

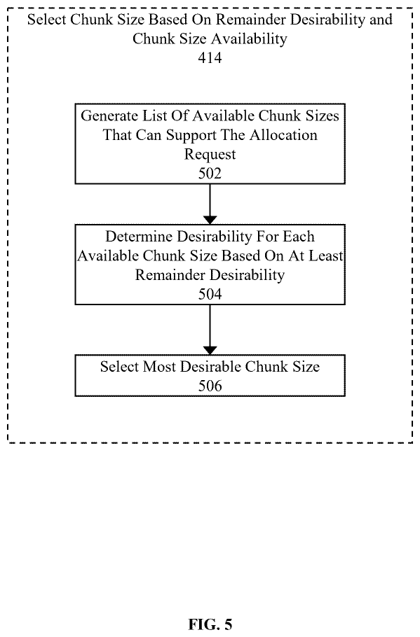

On the other hand, if an exact fit is not possible as determined at 411, the process proceeds to 413 where it is determined whether there are any chunks available that are larger than the requested size. In response to a positive determination, the process proceeds to 414 where a chunk size is selected based on at least remainder desirability and chunk size availability. This is discussed further in regard to FIG. 5. Briefly, this can comprise selecting a chunk having a size such that a remainder from the allocation would be equal chunk size that corresponds to the lowest supply/demand ratio, provided that there is at least one chunk of the selected size as represented by the chunk supply data.

Once the chunk size is determined, a chunk having the selected size is allocated at 416 and the chunk allocation size (see e.g., 451) and the remainder (see e.g., 452), which would not be zero, is captured and transmitted to 226 as discussed herein. In some embodiments, in response to the allocation, the storage unit availability representation is updated at 418. Such an approach, maintains the storage unit availability representation in an accurate manner to allow for the selection of chunks of a selected size.

However, if the determination at 413 is negative, a compaction process is started at 402. For example, the process can comprise a defragmentation process that rearranges the location of data on a storage element in a matter that avoids the creation of fragments (e.g., holes) that are otherwise unused. In some embodiments, the compaction operations at trigger a subsequent generation (regeneration) of the storage unit availability representation at 212 and processing of the regenerated storage unit availability representation at 214 before returning to 411 to determine if an exact-fit allocation approach can be used for the pending allocation request. In some embodiments, the chunk supply and demand data is monitored to detect excessive fragmentation of a corresponding storage element (e.g., by applying a threshold to an average supply/demand ratio value), and is used to trigger compaction in advance of receiving an allocation request that might require compaction.

FIG. 4B illustrates a flow for updating chunk supply data, chunk demand data, and chunk supply/demand ratio data after a previously free chunk is allocated according to some embodiments. However, other approaches could be provided that perform the same or essentially the same operations but in a different order.

Generally, the process is initiated in response to receipt of an allocation chunk size (see e.g., 451 and a remainder (see e.g., 452). Generally, the process starts at 420 where a corresponding supply count is decremented. For example, the chunk allocation size (see 451) is used as an index to identify the corresponding chunk supply count which is then decremented by one to represent the allocation of a chunk of that size.

After the chunk supply data has been updated to reflect the use of a chunk of the specified size, the remainder is used to determine whether there is a correspond chunk supply value to be incremented. Specifically, in response to a determination that the remainder is not equal to zero, the process proceeds to 422 where a corresponding chunk supply count is incremented—e.g., an entry for a chunk having a size equal to the remainder is incremented. If there is no entry having a chunk size equal to the remainder, such an entry is created with the count set to one.

In some embodiments, at 424, a corresponding chunk demand entry is added to a chunk demand log. For example, a chunk demand log (see e.g., 438) is maintained that includes demand entries that are chronologically ordered (e.g., using a time stamp or sequence number).

Similarly, in some embodiments, the chunk demand log is cleaned up at 426. For instance, if the demand log is to comprises a maximum number of entries, the oldest entry would be removed whenever that maximum is exceeded. Alternatively, if the chunk demand log is to comprise all entries for a given sliding window, any entries that fall outside of that windows are removed or at least not considered when forming the chunk demand data.

In some embodiments, at 428, chunk demand counts are updated based on one or more chunk demand changes (see e.g., 453). For instance, the chunk demand count for the chunk size allocated (see e.g., 451) is incremented to represent the demand for which the allocation was just performed. Likewise, any demand values that corresponding to one or more entries that fall off the chunk demand log are decremented for each entry matching an entry so removed.

In some embodiments, the supply/demand ratio data is updated at 430. For instance, values in the supply/demand ratio data are recalculated based on the newly updated chunk supply data and chunk demand data. In some embodiments, supply/demand ratios are only calculated for corresponding chunk sizes that changed (e.g., when the supply value changes, demand value changes, or both the supply and demand values change). In some embodiments, the supply and demand ratio data is not maintained in storage on an ongoing basis, but is instead dynamically calculated as needed—e.g., as parts of determining remainder desirability.

FIG. 4C illustrates a flow for updating chunk supply data and chunk supply/demand ratio data after a previously used chunk is de-allocated according to some embodiments.

However, other approaches could be provided that perform the same or essentially the same operations but in a different order.

Generally, the process is initiated in response to receipt of an allocation request that specifies that a previously used chunk is to be de-allocated. To illustrate, when an allocation of storage is needed by a process it can be requested and processed as illustrated in FIGS. 4A and 4B. Similarly, when an allocation of storage is no longer needed by a process, the process can indicate that the previous allocation is to be returned to a pool of available storage—e.g., when a file is deleted, the corresponding storage could be de-allocated. Such requests would be received at 222 and processed at 224 to free the corresponding storage.

Additionally, as illustrated here, in response to the de-allocation request the supply and potentially the supply/demand ratio data is updated to reflect the de-allocation. For instance, at 224 information representing the de-allocated chunk is received—e.g., the location and size of the chunk. At 460, a temporary value (e.g., X) is set to equal the chunk size that was freed and the location information is represented using an offset.

At 461, the location of the chunk is used to determine whether a chunk immediately preceding the recently freed chunk (preceding chunk) is used. In response, to a determination that the preceding chunk was used the process proceeds to 465 where is similar determination is made as to whether a chunk immediately proceeding the recently freed chunk is used. If either or both of the immediately preceding and proceeding chunks are not used then the corresponding storage they represent will be combined before created or updating a corresponding chunk supply count. Specifically, responsive to a determination at 461 that the preceding chunk is not used the process proceeds to 462 where X is incremented by the size of the free immediately preceding adjacent chunk and the location information (e.g., offset) is decremented to reference the start of the free immediately preceding adjacent chunk. Additionally, at 464 the corresponding chunk supply count (for the immediately preceding adjacent chunk) is decremented as that chunk will now be accounted for as part of the de-allocated chunk. After which the process proceeds to 465. Responsive to a determination at 465 that the proceeding chunk is not used the process proceeds to 466 where X is incremented by the size of the free immediately proceeding adjacent chunk. Additionally, at 468 the corresponding chunk supply count (for the immediately proceeding adjacent chunk) is decremented as that chunk will now be accounted for as part of the de-allocated chunk.

Either after 468 or 465 the process proceeds to 470 where a corresponding chunk supply count is incremented—e.g., an entry for a chunk having a size equal to X is incremented. If there is no entry having a chunk size equal to X, such an entry is created with the count set to one. Additionally, in some embodiments, the storage unit availability representation (see e.g., 136) is updated at 472.

In some embodiments, the supply/demand ratio data is updated at 474. For instance, values in the supply/demand ratio data are recalculated based on the newly updated chunk supply data and existing chunk demand data. In some embodiments, supply/demand ratios are only calculated for corresponding chunk sizes that changed. In some embodiments, the supply and demand ratio data is not maintained in storage on an ongoing basis, but is instead dynamically calculated as needed—e.g., as parts of determining remainder desirability.

FIG. 5 illustrates a flow for selecting a chunk size based on desirability of a remainder and chunk size availability according to some embodiments. However, other approaches could be provided that perform the same or essentially the same operations but in a different order.

In some embodiments, the process starts at 502 where a list of available chunk sizes that can support the allocation request is generated. For instance, the chunk supply data (see e.g., 137) is processed to identify all chunk sizes that are greater than the size required for allocation and have a count of one or more.

The list is then populated with a desirability value—e.g., for each remainder that would result of an allocation of the corresponding chunk size identified therein. For example, desirability can comprise the corresponding supply/demand ratio value for the remainder. In some embodiments, the desirability comprises a corresponding weighted supply/demand ratio value—e.g., one that includes a weighting based on the supply of the chunk size that would be consumed by the allocation, a supply/demand ration value of the chunk size that would be consumed by the allocation, or a combination thereof. At 506 the chunk size that is most desirable is selected to service the needed allocation.

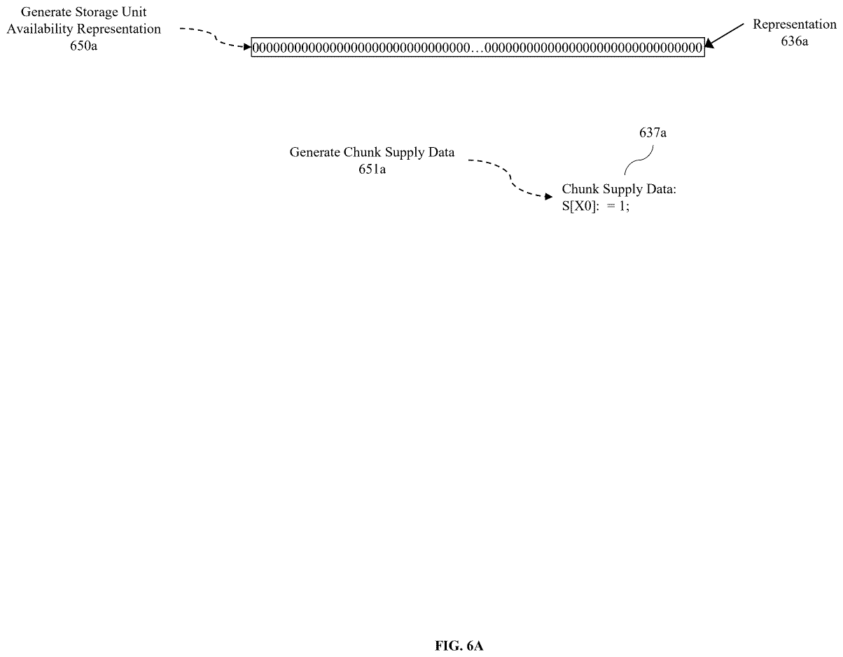

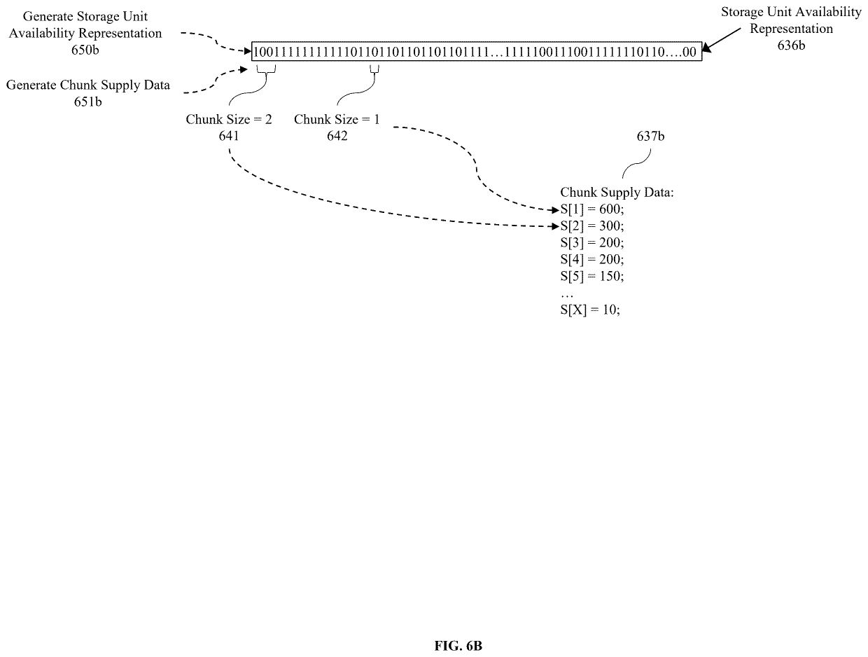

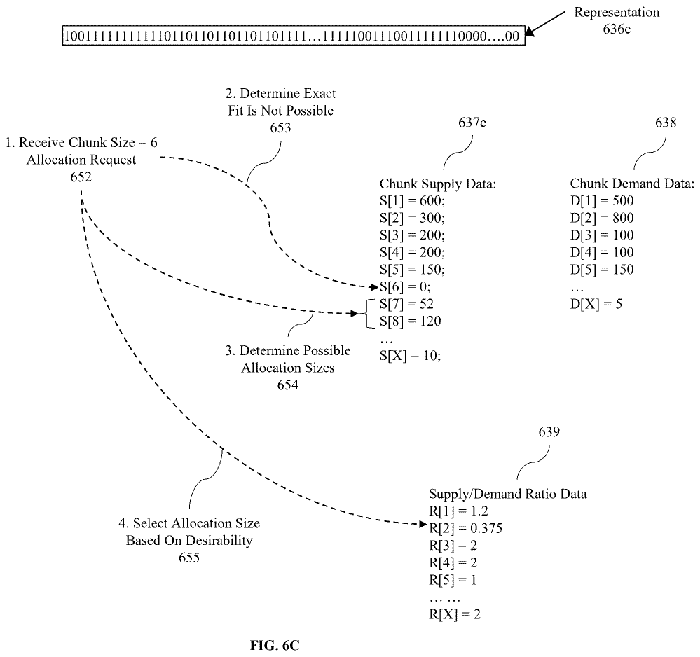

FIG. 6A provides an illustrative example of chunk supply data generation for a storage element with all allocation units available according to some embodiments.

For example, at 650a the storage unit availability representation (see e.g., 636a similar to that discussed herein as 136) is generated that comprises all zeros indicated that all storage units are available for allocation. Subsequently, at 651a the chunk supply data is generated (see e.g., 637a similar to that discussed herein as 137). Here the chunk supply data comprise a single entry that is the size of the number of storage units.

FIG. 6B provides an illustrative example of chunk supply data generation for a storage element with only some allocation units available according to some embodiments.

For example, at 650b the storage unit availability representation (see e.g., 636b similar to that discussed herein as 136) is generated that comprises a combination of zeros and ones in an order that is representative of the storage units available for allocation and the order that they are arranged. For instance, at 641 a chunk of size two can be found, while at 642 a chunk of size one can be found. As provided here the chunk of size two (see 641) is only counted as a chunk of size two, and is not counted as two chunks of size one. As discussed herein, the storage unit availability representation (see 636b) can be traversed to generate chunk supply data which is then maintained at 637b.

While FIG. 6A illustrates an instance where the storage element in initialized in an empty (clean) state, FIG. 6B illustrates an instance where the storage element is initiated in a used (dirty) state.

FIG. 6C provides an illustrative example of how to determine chunk size allocation in the event that an exact fit approach is not possible according to some embodiments.

For example, the storage unit availability representation (see e.g., 636c similar to that discussed herein as 136) is illustrated herein and is associated with chunk supply data 637c (similar to 137). Additionally, the storage element represented (e.g., 115) is associated with chunk demand data (see e.g., 638 similar to 138 herein). In some embodiments, the chunk demand data is generated or utilized only after threshold amount of time has passed or a threshold number of allocation demands have occurred. Similarly, the supply/demand ratio data (see e.g., 639 similar to 139 herein) is generated based on current chunk supply and chunk demand data. The present example illustrates only a limited number of entries in the chunk supply data, chunk demand data, and the supply/demand ratio data though any number of entries may be provided. Additionally, in some embodiments, chunk sizes that are not associated with any demand or with any availability may be omitted from the corresponding chunk supply data or chunk demand data. Likewise, chunk sizes that are not associated with any demand or with any availability may be omitted from supply/demand ratio data as well as any values where the demand is equal to zero to avoid dividing by zero (as illustrated here, the supply/demand ratio is the supply divided by the corresponding demand—e.g., R[3]=S[3]/D[3]=200/100=2 in the present example).

As illustrated, at 652 an allocation request for a chunk of size six is received. Subsequently, at 653 the process determines that an exact fit is not possible—e.g., due to a corresponding entry (see S[6]=0) or lack thereof. Possible allocation sizes are then determined at 654 by traversing the chunk supply data (see 637c). While the present example illustrates only a couple of relevant values (see e.g., S[7], S[8], S[x]) in an active system there may be many more values. At 655, the allocation size is selected based on desirability. Here the most desirable allocation size is selected based on the ratio of supply over demand for the remainder where a lower value is more desirable as it represents a low supply in comparison to the corresponding demand. As R[2] represent the lowest value it represents the most desirable remainder and thus the allocation size that provides the most desirable remainder is selected (e.g., S[8]).

### System Architecture

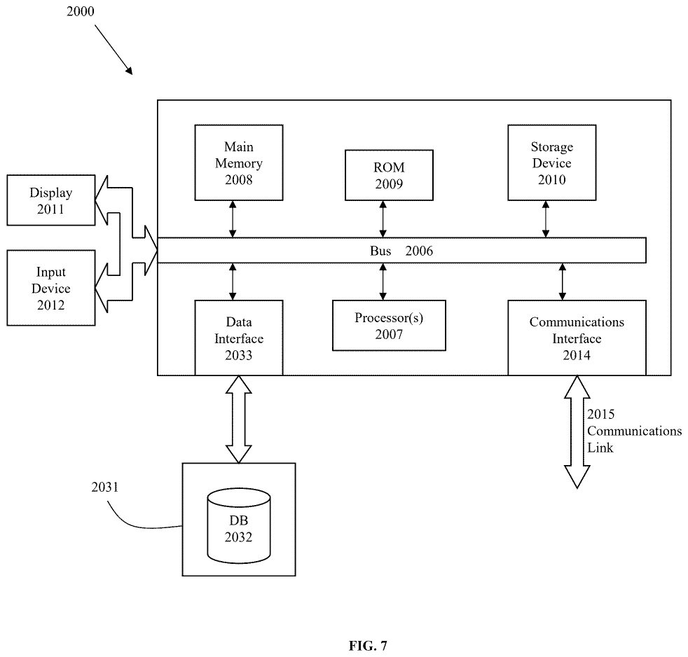

FIG. 7 is a block diagram of an illustrative computing system 2000 suitable for implementing an embodiment of the present invention. Computer system 2000 includes a bus 2006 or other communication mechanism for communicating information, which interconnects subsystems and devices, such as processor 2007, system memory 2008 (e.g., RAM), static storage device 2009 (e.g., ROM), disk drive 2010 (e.g., magnetic or optical), communication interface 2014 (e.g., modem or Ethernet card), display 2011 (e.g., CRT or LCD), input device 2012 (e.g., keyboard), and cursor control.

According to one embodiment of the invention, computer system 2000 performs specific operations by processor 2007 executing one or more sequences of one or more instructions contained in system memory 2008. Such instructions may be read into system memory 2008 from another computer readable/usable medium, such as static storage device 2009 or disk drive 2010. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 2007 for execution. Such a medium may take many forms, including but not limited to, non-volatile media and volatile media. Non-volatile media includes, for example, optical or magnetic disks, such as disk drive 2010. Volatile media includes dynamic memory, such as system memory 2008.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, cloud-based storage, or any other medium from which a computer can read.

In an embodiment of the invention, execution of the sequences of instructions to practice the invention is performed by a single computer system 2000. According to other embodiments of the invention, two or more computer systems 2000 coupled by communication link 2015 (e.g., LAN, PTSN, or wireless network) may perform the sequence of instructions required to practice the invention in coordination with one another.

Computer system 2000 may transmit and receive messages, data, and instructions, including program, i.e., application code, through communication link 2015 and communication interface 2014. Received program code may be executed by processor 2007 as it is received, and/or stored in disk drive 2010, or other non-volatile storage for later execution. Data may be accessed from a database 2032 that is maintained in a storage device 2031, which is accessed using data interface 2033.

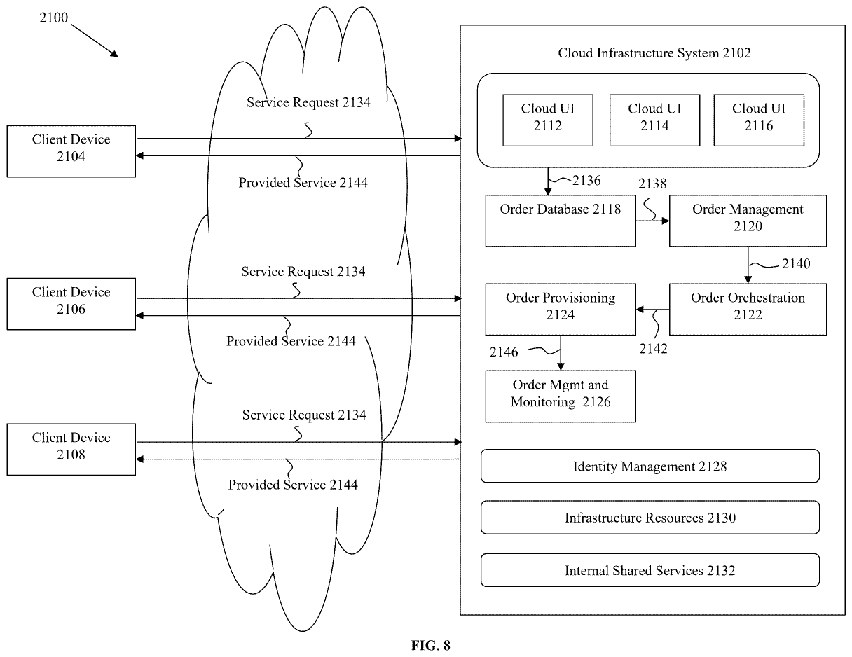

FIG. 8 is a simplified block diagram of one or more components of a system environment 2100 by which services provided by one or more components of an embodiment system may be offered as cloud services, in accordance with an embodiment of the present disclosure. In the illustrated embodiment, system environment 2100 includes one or more client computing devices 2104, 2106, and 2108 that may be used by users to interact with a cloud infrastructure system 2102 that provides cloud services. The client computing devices may be configured to operate a client application such as a web browser, a proprietary client application, or some other application, which may be used by a user of the client computing device to interact with cloud infrastructure system 2102 to use services provided by cloud infrastructure system 2102.

It should be appreciated that cloud infrastructure system 2102 depicted in the figure may have other components than those depicted. Further, the embodiment shown in the figure is only one example of a cloud infrastructure system that may incorporate an embodiment of the invention. In some other embodiments, cloud infrastructure system 2102 may have more or fewer components than shown in the figure, may combine two or more components, or may have a different configuration or arrangement of components.

Client computing devices 2104, 2106, and 2108 may be devices similar to those described above for FIG. 7. Although system environment 2100 is shown with three client computing devices, any number of client computing devices may be supported. Other devices such as devices with sensors, etc. may interact with cloud infrastructure system 2102.

Network(s) 2110 may facilitate communications and exchange of data between clients 2104, 2106, and 2108 and cloud infrastructure system 2102. Each network may be any type of network familiar to those skilled in the art that can support data communications using any of a variety of commercially available protocols. Cloud infrastructure system 2102 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 2102 may include a suite of applications, middleware, and database service offerings that are delivered to a customer in a self-service, subscription-based, elastically scalable, reliable, highly available, and secure manner.

In various embodiments, cloud infrastructure system 2102 may be adapted to automatically provision, manage and track a customer's subscription to services offered by cloud infrastructure system 2102. Cloud infrastructure system 2102 may provide the cloud services via different deployment models. For example, services may be provided under a public cloud model in which cloud infrastructure system 2102 is owned by an organization selling cloud services and the services are made available to the general public or different industry enterprises. As another example, services may be provided under a private cloud model in which cloud infrastructure system 2102 is operated solely for a single organization and may provide services for one or more entities within the organization. The cloud services may also be provided under a community cloud model in which cloud infrastructure system 2102 and the services provided by cloud infrastructure system 2102 are shared by several organizations in a related community. The cloud services may also be provided under a hybrid cloud model, which is a combination of two or more different models.

In some embodiments, the services provided by cloud infrastructure system 2102 may include one or more services provided under Software as a Service (Saas) category, Platform as a Service (PaaS) category, Infrastructure as a Service (IaaS) category, or other categories of services including hybrid services. A customer, via a subscription order, may order one or more services provided by cloud infrastructure system 2102. Cloud infrastructure system 2102 then performs processing to provide the services in the customer's subscription order.

In some embodiments, the services provided by cloud infrastructure system 2102 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 2102 may also include infrastructure resources 2130 for providing the resources used to provide various services to customers of the cloud infrastructure system. In one embodiment, infrastructure resources 2130 may include pre-integrated and optimized combinations of hardware, such as servers, storage, and networking resources to execute the services provided by the PaaS platform and the SaaS platform.

In some embodiments, resources in cloud infrastructure system 2102 may be shared by multiple users and dynamically re-allocated per demand. Additionally, resources may be allocated to users in different time zones. For example, cloud infrastructure system 2130 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 2132 may be provided that are shared by different components or modules of cloud infrastructure system 2102 and by the services provided by cloud infrastructure system 2102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

In certain embodiments, cloud infrastructure system 2102 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 2102, and the like.

In one embodiment, as depicted in the figure, cloud management functionality may be provided by one or more modules, such as an order management module 2120, an order orchestration module 2122, an order provisioning module 2124, an order management and monitoring module 2126, and an identity management module 2128. These modules may include or be provided using one or more computers and/or servers, which may be general purpose computers, specialized server computers, server farms, server clusters, or any other appropriate arrangement and/or combination.

In operation 2134, a customer using a client device, such as client device 2104, 2106 or 2108, may interact with cloud infrastructure system 2102 by requesting one or more services provided by cloud infrastructure system 2102 and placing an order for a subscription for one or more services offered by cloud infrastructure system 2102. In certain embodiments, the customer may access a cloud User Interface (UI), cloud UI 2112, cloud UI 2114 and/or cloud UI 2116 and place a subscription order via these UIs. The order information received by cloud infrastructure system 2102 in response to the customer placing an order may include information identifying the customer and one or more services offered by the cloud infrastructure system 2102 that the customer intends to subscribe to.

After an order has been placed by the customer, the order information is received via the cloud UIs, 2112, 2114 and/or 2116. At operation 2136, the order is stored in order database 2118. Order database 2118 can be one of several databases operated by cloud infrastructure system 2118 and operated in conjunction with other system elements. At operation 2138, the order information is forwarded to an order management module 2120. In some instances, order management module 2120 may be configured to perform billing and accounting functions related to the order, such as verifying the order, and upon verification, booking the order. At operation 2140, information regarding the order is communicated to an order orchestration module 2122. Order orchestration module 2122 may utilize the order information to orchestrate the provisioning of services and resources for the order placed by the customer. In some instances, order orchestration module 2122 may orchestrate the provisioning of resources to support the subscribed services using the services of order provisioning module 2124.

In certain embodiments, order orchestration module 2122 enables the management of business processes associated with each order and applies business logic to determine whether an order should proceed to provisioning. At operation 2142, upon receiving an order for a new subscription, order orchestration module 2122 sends a request to order provisioning module 2124 to allocate resources and configure those resources needed to fulfill the subscription order. Order provisioning module 2124 enables the allocation of resources for the services ordered by the customer. Order provisioning module 2124 provides a level of abstraction between the cloud services provided by cloud infrastructure system 2102 and the physical implementation layer that is used to provision the resources for providing the requested services. Order orchestration module 2122 may thus be isolated from implementation details, such as whether or not services and resources are provisioned on the fly or pre-provisioned and only allocated/assigned upon request.

At operation 2144, once the services and resources are provisioned, a notification of the provided service may be sent to customers on client devices 2104, 2106 and/or 2108 by order provisioning module 2124 of cloud infrastructure system 2102.

At operation 2146, the customer's subscription order may be managed and tracked by an order management and monitoring module 2126. In some instances, order management and monitoring module 2126 may be configured to collect usage statistics for the services in the subscription order, such as the amount of storage used, the amount data transferred, the number of users, and the amount of system up time and system down time.

In certain embodiments, cloud infrastructure system 2102 may include an identity management module 2128. Identity management module 2128 may be configured to provide identity services, such as access management and authorization services in cloud infrastructure system 2102. In some embodiments, identity management module 2128 may control information about customers who wish to utilize the services provided by cloud infrastructure system 2102. Such information can include information that authenticates the identities of such customers and information that describes which actions those customers are authorized to perform relative to various system resources (e.g., files, directories, applications, communication ports, memory segments, etc.) Identity management module 2128 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

Additionally, the approach disclosed herein for an approach for efficient storage allocation based on supply and demand matching addresses at least some of the issues of prior techniques suffer from, such as challenges associated with fragmentation of a storage space.

1. A computer-implemented method, comprising:
generating a storage unit availability representation of a storage element;
processing the storage unit availability representation to generate chunk supply data, wherein the chunk supply data maps chunk size values to respective count values, and each respective count value of the respective count values indicates a number of available chunks having a corresponding chunk size value;
receiving an allocation request; and
processing the allocation request using allocation logic, wherein the allocation logic uses at least the chunk supply data and chunk demand data to determine a chunk size to use to satisfy the allocation request.

2. The computer-implemented method of claim 1, further comprising updating the chunk supply data by at least decrementing a respective count value corresponding to the chunk size, and updating the chunk demand data by incrementing a demand count value in the chunk demand data that corresponds to a chunk size of the allocation request.

3. The computer-implemented method of claim 2, wherein the allocation logic uses at least the chunk supply data and the chunk demand data to form ratios used to determine the chunk size to use for the allocation request, wherein a ratio comprises a count value in the chunk supply data divided by a corresponding demand count value in the chunk demand data.

4. The computer-implemented method of claim 3, wherein the ratios are calculated in response to receiving the allocation request.

5. The computer-implemented method of claim 1, further comprising updating the chunk supply data by at least incrementing a different count value that indicates a number of available chunks having a different chunk size value that is equal to a chunk size of a remainder from processing the allocation request.

6. The computer-implemented method of claim 1, wherein chunk size values represent multiples of a smallest allocation size that is supported for the storage element.

7. The computer-implemented method of claim 1, wherein chunks represent a contiguous collection of one or more storage units of the storage element, the chunk size values are equal to a number of corresponding contiguous storage units, and each storage unit is only counted toward one of the chunks.

8. The computer-implemented method of claim 1, wherein chunk demand entries are added to an allocation log to track allocation requests, and the chunk demand entries that match inclusion criteria are processed to generate the chunk demand data.

9. The computer-implemented method of claim 1, further comprising:
receiving a subsequent allocation request, wherein the subsequent allocation request comprises a request for an allocation of a chunk that is equal to a chunk size of a remainder from processing the allocation request; and
processing the subsequent allocation request using the allocation logic at least by determining that an exact-fit allocation technique is to be used to satisfy the subsequent allocation request.

10. A non-transitory computer readable medium having stored thereon a sequence of instructions which, when executed by a processor causes a set of acts comprising:
generating a storage unit availability representation of a storage element;
processing the storage unit availability representation to generate chunk supply data, wherein the chunk supply data maps chunk size values to respective count values, and each respective count value of the respective count values indicates a number of available chunks having a corresponding chunk size value;
receiving an allocation request; and
processing the allocation request using allocation logic, wherein the allocation logic uses at least the chunk supply data and chunk demand data to determine a chunk size to use to satisfy the allocation request.

11. The non-transitory computer readable medium of claim 10, wherein the set of acts further comprise updating the chunk supply data by at least decrementing a respective count value corresponding to the chunk size, and updating the chunk demand data by incrementing a demand count value in the chunk demand data that corresponds to a chunk size of the allocation request.

12. The non-transitory computer readable medium of claim 11, wherein the allocation logic uses at least the chunk supply data and the chunk demand data to form ratios used to determine the chunk size to use for the allocation request, wherein a ratio comprises a count value in the chunk supply data divided by a corresponding demand count value in the chunk demand data.

13. The non-transitory computer readable medium of claim 12, wherein the ratios are calculated in response to receiving the allocation request.

14. The non-transitory computer readable medium of claim 10, wherein the set of acts further comprise updating the chunk supply data by at least incrementing a different count value that indicates a number of available chunks having a different chunk size value that is equal to a chunk size of a remainder from processing the allocation request.

15. The non-transitory computer readable medium of claim 10, wherein chunk size values represent multiples of a smallest allocation size that is supported for the storage element, chunks represent a contiguous collection of one or more storage units of the storage element, the chunk size values are equal to a number of corresponding contiguous storage units, and each storage unit is only counted toward one of the chunks.

16. The non-transitory computer readable medium of claim 10, wherein chunk demand entries are added to an allocation log to track allocation requests, and the chunk demand entries that match inclusion criteria are processed to generate the chunk demand data.

17. The non-transitory computer readable medium of claim 10, wherein the set of acts further comprise:
receiving a subsequent allocation request, wherein the subsequent allocation request comprise a request for an allocation of a chunk that is equal to a chunk size of a remainder from processing the allocation request; and
processing the subsequent allocation request using the allocation logic at least by determining that an exact-fit allocation technique is to be used to satisfy the subsequent allocation request.

18. A computing system comprising:
a memory to hold a set of instructions; and
a computer processor to execute the set of instructions, which when executed cause a set of acts comprising:
generating a storage unit availability representation of a storage element;
processing the storage unit availability representation to generate chunk supply data, wherein the chunk supply data maps chunk size values to respective count values, and each respective count value of the respective count values indicates a number of available chunks having a corresponding chunk size value;
receiving an allocation request; and
processing the allocation request using allocation logic, wherein the allocation logic uses at least the chunk supply data and chunk demand data to determine a chunk size to use to satisfy the allocation request.

19. The computing system of claim 18, wherein the set of acts further comprise updating the chunk supply data by at least decrementing a respective count value corresponding to the chunk size, and updating the chunk demand data by incrementing a demand count value in the chunk demand data that corresponds to a chunk size of the allocation request.

20. The computing system of claim 19, wherein the allocation logic uses at least the chunk supply data and the chunk demand data to form ratios used to determine the chunk size to use for the allocation request, wherein a ratio comprises a count value in the chunk supply data divided by a corresponding demand count value size in the chunk demand data.
